(19) United States
(12) Patent Application Publication
(10) Pub. No.: US 2014/0102986 A1
(43) Pub. Date: Apr. 17, 2014

(54) METHOD AND APPARATUS FOR PERFORMING SURFACE FILTRATION FOR WASTEWATER MERCURY REMOVAL

(71) Applicant: EXXONMOBIL RESEARCH AND ENGINEERING COMPANY, Annandale, NJ (US)

(72) Inventors: David A. MASCIOLA, Alexandria, VA (US); Owen R. MICHAELIS, Singapore (SG)

(73) Assignee: ExxonMobil Research and Engineering Company, Annandale, NJ (US)

(21) Appl. No.: 13/650,710

(22) Filed: Oct. 12, 2012

(51) Int. Cl. C02F 1/62; C02F 1/28; B01D 29/00; B01D 29/37; C02F 1/52; B01D 29/50; C02F 103/36; C02F 101/20

(52) U.S. Cl. 210/669; 210/767; 210/702; 210/723; 210/806; 210/348; 210/198.1; 210/295; 210/486; 210/346

(57) ABSTRACT

A method and treatment unit for removing particulate mercury from aqueous streams such as wastewater streams from hydrocarbon processing is disclosed. Mercury solids are removed by means of a surface filter configured in the shape of a bag. The separated solid mercury can be thickened and dewatered by removing the spent filter bag from service and allowing the water to drain and/or evaporate. The dewatered solids can then be disposed of together with the spent bag to an approved solid waste disposal facility. Coagulants, flocculants, and mercury precipitants can be injected upstream of the filter bag if required to increase removal efficiency by precipitating dissolved ionic mercury and increasing the particle size of the mercury solids. Following bag filtration, activated carbon or an alternative technology (e.g., mercury specific ion exchange resin or adsorbent) can be applied to remove any trace concentrations of dissolved elemental and organic forms of mercury if required based on local discharge requirements.

### FIELD OF THE INVENTION

The presently disclosed subject matter relates a to method and apparatus for removing mercury from aqueous streams and, in particular, to methods and treatment units for removing mercury from wastewater streams from petroleum refineries and other petroleum processing installations.

### BACKGROUND OF THE INVENTION

Natural gas and crude oils produced in certain areas of the world contain mercury in quantities sufficient to render their processing problematical. For example, hydrocarbon condensates derived from natural gas produced in certain regions of Southeast Asia may contain over 1000 parts per billion by weight (ppbw) of mercury. The produced waters from gas and oil wells with elevated levels of mercury may also contain high levels of mercury precluding their discharge to the environment as a direct result of contact between the water and the oil or gas in the subterranean production interval. Wastewater streams associated with processing the gas and oil may also contain mercury arising from contact between process water streams and hydrocarbon streams. The contact may take place, for example, by the use of water or aqueous treatment streams to remove other contaminants such as nitrogenous compounds.

The mercury may be present in several forms including ionic, elemental, particulate and organic. Crude oils, for example, may contain elemental mercury, but this may be oxidized in various process units to produce water-soluble salts (Hg⁺, Hg²⁺) and complexes. Additionally, anaerobic bacteria can convert certain forms of mercury to water-soluble organic forms so that transfer between species can occur readily.

The presence of mercury raises problems of two kinds First, mercury may attack the metals for processing equipment through the formation of amalgams; this is a problem that is especially notable with items made of aluminum and aluminum alloys, such as the cold boxes in cryogenic plants, for example the ethylene separators found in petrochemical units and in natural gas treatment installations. The presence of mercury on the equipment may also dictate its treatment as hazardous waste when removed from service. Mercury poisoning may also reduce the life of processing catalysts.

Second, mercury, as an elemental impurity that cannot be destroyed but only moved from one stream to another, will often enter process water streams. This may occur by direct contact with the stream, for example, during washing or from the use of process steam. Recent studies have shown that as much as 80% of the mercury in the crude oil can enter a refinery wastewater stream. Increasingly stringent environmental regulations make it necessary to remove the mercury from the water before it can be discharged to the environment. The discharge target may be as low as 12 ng/L.

Currently, few technologies are available for removing mercury from streams of wastewater and produced water. The main commercial technology available for treating mercury in water consists of adding one of several commercially-available precipitants, usually sulfided polymers, to precipitate dissolved ionic mercury and remove it by means of gas or air flotation. A technique of this kind is described in U.S. Pat. No. 6,635,182 to Coleman. Although this method may be effective at removing the bulk of mercury found in wastewater (mercury solids and dissolved ionic species as Hg²⁺), the physical facilities needed to implement and operate the process can be expensive and occupy a large footprint. Chemical addition and flotation separator facilities are required. Additionally, under this method the mercury is removed with the “float,” which is a dilute stream (˜1% to 5% solids) that typically requires more facilities for thickening and/or dewatering to reduce the “float” or sludge volume before waste disposal. Additionally, this method cannot remove all species of mercury species that may be present, including very small insoluble particulate mercury compounds, elemental mercury (Hg(0)), present either as such or dissolved in minor amounts in the water, and organic mercury, principally monomethyl and dimethyl mercury. Where significant amounts of mercury or numerous different species are present and effluent limits are low, existing technologies are not likely to remove the amounts of mercury necessary to achieve environmental compliance.

Other proposals for treating aqueous streams to remove mercury and other heavy metals are found in U.S. Pat. No. 4,814,091 to Napier, U.S. Pat. No. 5,667,694 to Cody, U.S. Pat. No. 6,165,366 to Sarangapani and U.S. Pat. No. 7,092,202 to Zhuang. Prefiltration followed by pH adjustment and sulfide precipitation followed by flocculation and post filtration is used in the method of U.S. Pat. No. 4,814,091. The method described in U.S. Pat. No. 5,667,694 uses an organoclay sorbent, which can then be separated from the water, containing the removed metal. A treatment better adapted to continuous use is described in U.S. Pat. No. 6,165,366, which uses sequential hypochlorite oxidation, filtration and removal of organics using activated carbon. In the method described in U.S. Pat. No. 7,029,202, a lignin derivative is used initially to form a complex compound with the mercury or other metal after which a coagulant is used to form a floc which is then separated as a sludge. These methods have, however, not shown themselves to be sufficient to remove mercury in many wastewater streams to the levels needed for regulatory compliance.

There is a need for a process and treatment unit for removing mercury from an aqueous stream that addresses and overcomes the shortcomings of the currently available technology.

### SUMMARY OF THE INVENTION

The presently disclosed subject matter is directed to a processing technique and system for removing mercury from aqueous streams (e.g., wastewater, produced water, process streams) that provides a cost effective alternative to remove particulate and ionic species of mercury. The objective for this technique and system is for achieving an effective removal of the mercury contaminant to levels acceptable for discharge to the environment.

The presently disclosed subject matter uses a filtration unit having at least one surface filtration unit to remove particulate mercury from wastewater. The surface filtration unit is configured as a closed end bag or compartment herein after referred to as a “filter bag”. The aqueous stream is fed inside the filter bag where the solids are trapped inside. Once the filter bag is plugged (i.e., it can no longer filter mercury or it is full such that the aqueous stream can no longer pass through, it can be removed from service and replaced with a new filter bag. The plugged filter bag can be allowed to thicken/dewater naturally, without additional facilities. When the material inside the filter bag has reached acceptable water content, the filter bag, including removed mercury solids, can be transferred together to a solid waste contractor for disposal.

It is contemplated that a mercury precipitant may be injected into the aqueous stream upstream of the filter bag to ensure any dissolved ionic species (Hg²⁺ and associated complexes) are also in particulate form and can be removed by the filter bag. Wastewater coagulants and flocculants can also be injected into the aqueous stream upstream to ensure the mercury particulates are large enough to be removed by the filter and optimize mercury removal versus filter run length. Additionally, another technology (e.g., activated carbon) can be installed downstream if needed to remove trace levels of other mercury species (e.g., elemental and organic) and achieve compliance with increasingly stringent environmental regulations (e.g., as low as 12 ng/L).

The mercury precipitant may comprise a compound that reacts with the dissolved mercury compounds present in the aqueous stream to form water-insoluble sulfides of mercury. The mercury precipitant may suitably comprise an alkali metal sulfide, an alkali metal polysulfide, an alkaline earth metal sulfide, an alkaline earth metal polysulfide. Other mercury precipitants include thiazoles, alkali metal thiocarbamates, alkali metal dithiocarbamates, alkali metal xanthates and alkali metal trithiocarbonates. Polymeric dithiocarbamates are a suitable class of water-soluble mercury precipitants.

Coagulant or flocculating agents may be required in services with high levels of influent free hydrocarbon and/or suspended solids to help remove these contaminants and avoid adverse interactions with the mercury precipitant. Suitable coagulants and flocculants are organic or inorganic, or a combination of the two, and may be polymeric, either anionic or cationic and usually can be categorized as polyelectrolytes such as sodium aluminate, aluminum trihydrate, and ferric chloride. Polymeric organic coagulants and flocculants include the polyacrylamides, diallyldimethylammonium chloride (DADMAC) polymers, DADMAC-polyacrylamides and epichlorohydrin dimethylamine (EPI-DMA) polyamines. These coagulants and flocculants are typically added to aqueous stream prior to treatment of the stream in the filtration unit.

In accordance with the presently disclosed subject matter, the filtered aqueous stream may be further process, if needed, to remove any trace concentrations of other mercury species (i.e., elemental and organic) if required based on local discharge requirements and/or the specific source and nature of the raw wastewater (e.g., unique process that results in elevated concentrations of dissolved mercury species). Activated carbon can be used for this purpose as it has been shown to remove dissolved ionic mercury species as well as elemental and organic forms of mercury. There are alternatives to activated carbon that can be used for this polishing step depending on the specific characteristics (e.g., mercury speciation) of the wastewater; however, activated carbon is preferred as it should remove the widest range of mercury species present in these wastewaters.

The presently disclosed subject matter is directed to a method for removing mercury from an aqueous stream. The method includes providing an aqueous stream containing mercury. The method further includes passing the aqueous stream through a filtration unit to remove mercury forming a filtered aqueous stream having reduced mercury content, wherein the filtration unit includes at least one surface filtration unit, wherein the aqueous stream passes through the at least one surface filtration unit in order to form the filtered aqueous stream. The method may further include adding at least one mercury precipitant to the aqueous stream prior to passing the aqueous stream through the filtration unit, wherein the at least one mercury precipitant reacts with mercury dissolved in the aqueous stream to form a water-insoluble precipitate of a mercury compound. The water-insoluble precipitate is filtered out of the aqueous stream as the aqueous stream passes through the at least one surface filtration unit. The method may further include adding an amount at least one of a coagulant and a flocculent to the aqueous stream prior to passing the aqueous stream through the filtration unit. The coagulant and/or the flocculent is mixed with the mercury precipitant within the aqueous stream prior to passing the aqueous stream through the filtration unit. The method may further include passing the filtered aqueous stream through a treatment unit to remove residual mercury contained in the filtered aqueous stream. The treatment unit contains an activated carbon.

In accordance with the presently disclosed subject matter, each surface filtration unit has a surface filter. The surface filter may be in the form of an open end compartment having porous side walls such that the aqueous stream flows into the surface filter through the open end into an interior of the compartment, wherein the aqueous stream flows through the porous side walls to remove mercury forming a filtered aqueous stream having reduced mercury content. The filtration unit may comprise a first surface filtration unit having pores having a first size and a second filtration unit having pores having second size, wherein the first size is greater than the second size.

### BRIEF DESCRIPTION OF THE DRAWINGS

The invention will now be described in conjunction with the accompanying drawings in which like reference numerals describe like elements and wherein:

FIG. 1 is a process schematic for a mercury removal process in accordance with an embodiment of the presently disclosed subject matter.

FIG. 2 is a process schematic for a mercury removal process in accordance with another embodiment of the presently disclosed subject matter.

FIG. 3 is a process schematic for a mercury removal process in accordance with another embodiment of the presently disclosed subject matter.

FIG. 4 is a schematic of a filtration unit in accordance with the presently disclosed subject matter illustrating the passage of the aqueous stream through the filtration unit.

### DETAILED DESCRIPTION

The following preferred embodiments of the presently disclosed subject matter are described by way of illustration.

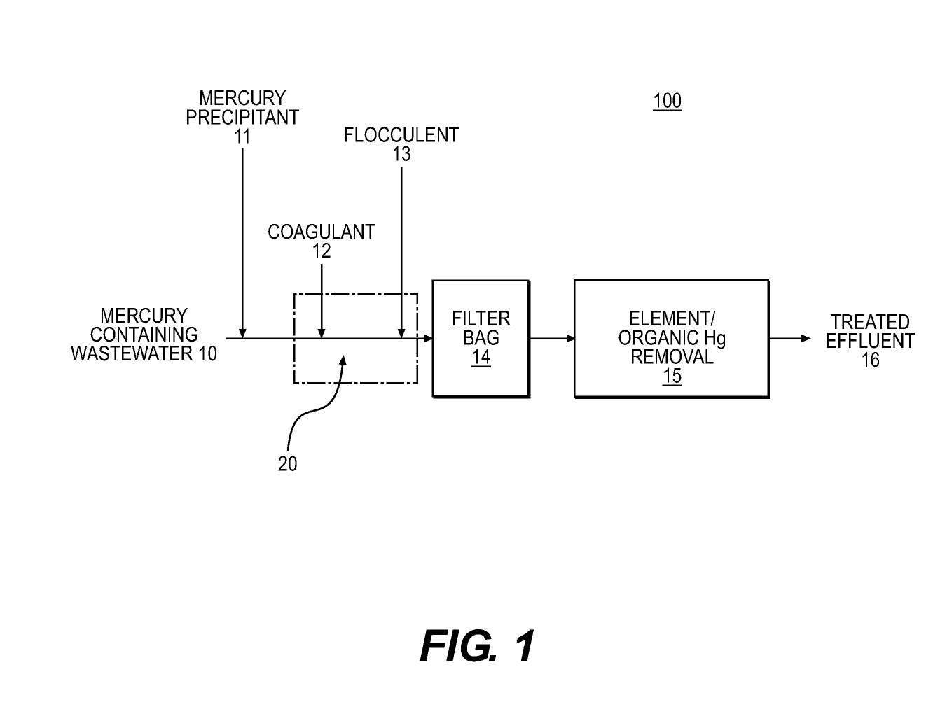

FIG. 1. illustrates a treatment unit 100 in accordance with the presently disclosed subject matter. As shown in FIG. 1, the mercury-containing aqueous stream enters a treatment unit 100 through line 10. A water-soluble mercury precipitant is fed in through line 11 to mix with the aqueous solution. A coagulant is fed in through line 12 to mix with the aqueous solution. A flocculent is fed in through line 13 to mix with the aqueous solution. It is also contemplated that the precipitant, the coagulant and the flocculent may be premixed and supplied to the aqueous stream through a single line. It is also contemplated that the precipitant, the coagulant and the flocculent may be mixed with the aqueous stream within a holding tank 20. The precipitant may be added to the stream prior to entry in the holding tank 20 with the coagulant and the flocculent being mixed with the aqueous stream within the holding tank. With such an arrangement, the coagulant and/or the flocculent may be supplied in liquid or solid form. After a suitable period of time such that mercury precipitates form, the mixtures of these materials with the aqueous stream may then supplied to treatment unit 100 or 300 for further processing at a predetermined flow rate.

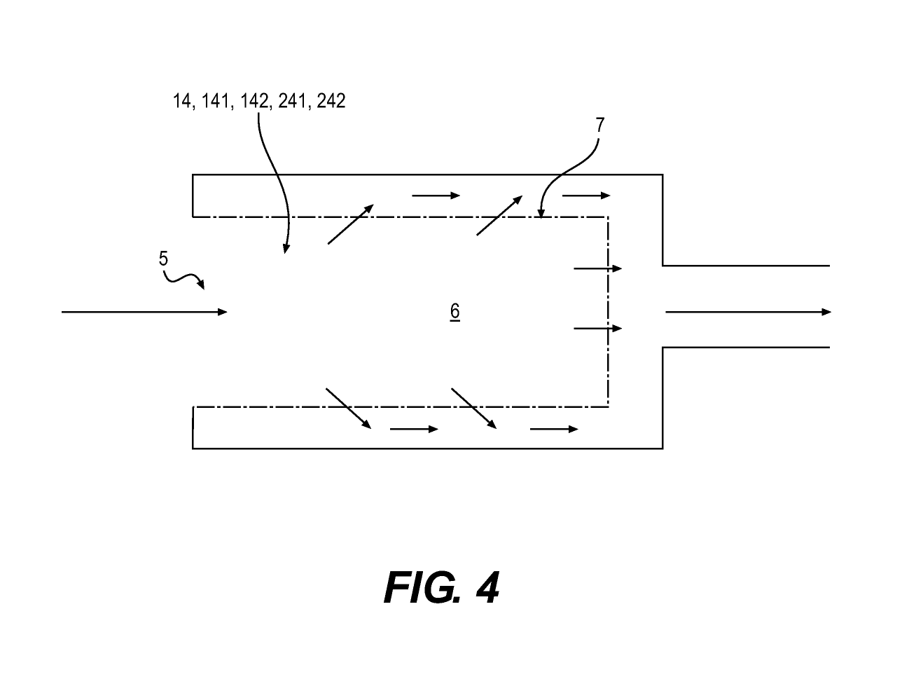

Upon mixing of the aqueous stream with the precipitant, the coagulant and the flocculent, which typically takes place readily in the flow lines or in a holding tank 20, a reaction occurs to precipitate dissolved ionic mercury out of aqueous stream. The aqueous stream is then fed into the mercury removal unit 100. The unit 100 contains a filter or filtration unit 14. The filter unit 14 contains a surface filter that is preferably a filter bag having a predetermined pore size. The aqueous stream passes through the surface filer such that precipitated mercury is trapped on one side of the surface filter because it is unable to flow through the pores within the surface filter. As shown in FIG. 4, the filter bag is configured as a closed end bag or compartment. The unfiltered aqueous stream is fed into the filter bag through the open end 5 of the compartment. The stream then flows from the interior 6 of the bag, through the bag wall 7 to outside the bag. The solids are trapped inside. Other filter configurations are contemplated including a series of filter trays for removing mercury but are not preferred because the use of the filter bag permits easy removal and changing of the filter when the filter bag is plugged or full.

The precipitated solids, and other mercury particulates, are separated from the aqueous stream by filtration as the aqueous stream flows through the filter unit 14. The flux rate through the filter unit is up to about 4 l/m²/min. Although a single unit 14 is illustrated, the presently disclosed subject matter is not intended to be so limited, rather, it is contemplated that two or more filter units 14 may be arranged in parallel to form parallel lines for treating the aqueous stream. With such an arrangement, the entire treatment unit 100 does not have to be shut down when the unit 14 is being serviced (e.g., the filter bag is replaced), rather, the aqueous stream can be diverted to another unit 14. The filtered aqueous stream is then fed to treatment unit 15 in which activated carbon or an alternative technology (e.g., mercury specific ion exchange resin or adsorbent) can be used to remove trace concentrations of other mercury species (i.e., elemental and organic mercury species). The aqueous stream, essentially free of all mercury species, then leaves the treatment unit 15 through line 16 and can be followed by other treatment steps that may be necessary or desirable, for example, biotreatment to reduce chemical oxygen demand or, if the stream is by now in compliance with applicable regulations, discharged to the environment.

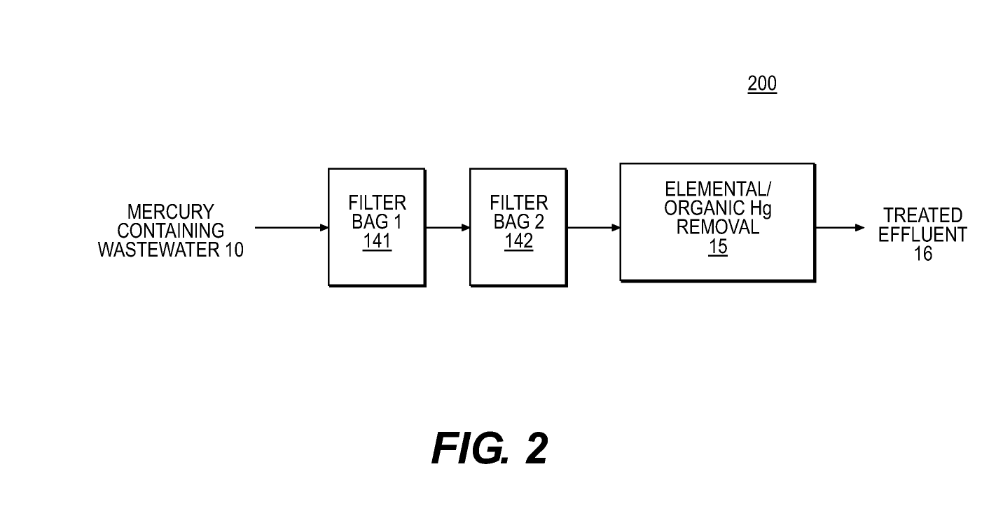

FIG. 2. illustrates another treatment unit 200 in accordance with the presently disclosed subject matter. As shown in FIG. 2, the mercury-containing aqueous stream enters a treatment unit 200 through line 10. Unlike treatment unit 100, there is no pre-treatment of the aqueous stream with a coagulant and a flocculent. It is also possible to eliminate the use of the precipitant. The aqueous stream is fed directly into the unit 200. The unit 200 contains a series of filter units 141 and 142. As discussed above in connection with unit 100, the unit 200 may have a plurality of units 141 and 142 arranged in parallel. Each of the filter unit 141 and 142 are preferably a filter bag having a predetermined pore size. The filter units 141 and 142 preferably have differing pore sizes. The pore size of the first filter unit 141 being larger than the pore size of the second filter unit 142. The precipitated solids, and other mercury particulates, are separated from the aqueous stream by filtration as the aqueous stream flows through the filter units 141 and 142. The filtered aqueous stream is then fed to treatment unit 15 in which activated carbon or an alternative technology (e.g., mercury specific ion exchange resin or adsorbent) can be used to remove trace concentrations of other mercury species (i.e., elemental and organic mercury species). The aqueous stream, essentially free of all mercury species, then leaves the treatment unit 15 through line 16 and can be followed by other treatment steps that may be necessary or desirable, for example, biotreatment to reduce chemical oxygen demand or, if the stream is by now in compliance with applicable regulations, discharged to the environment.

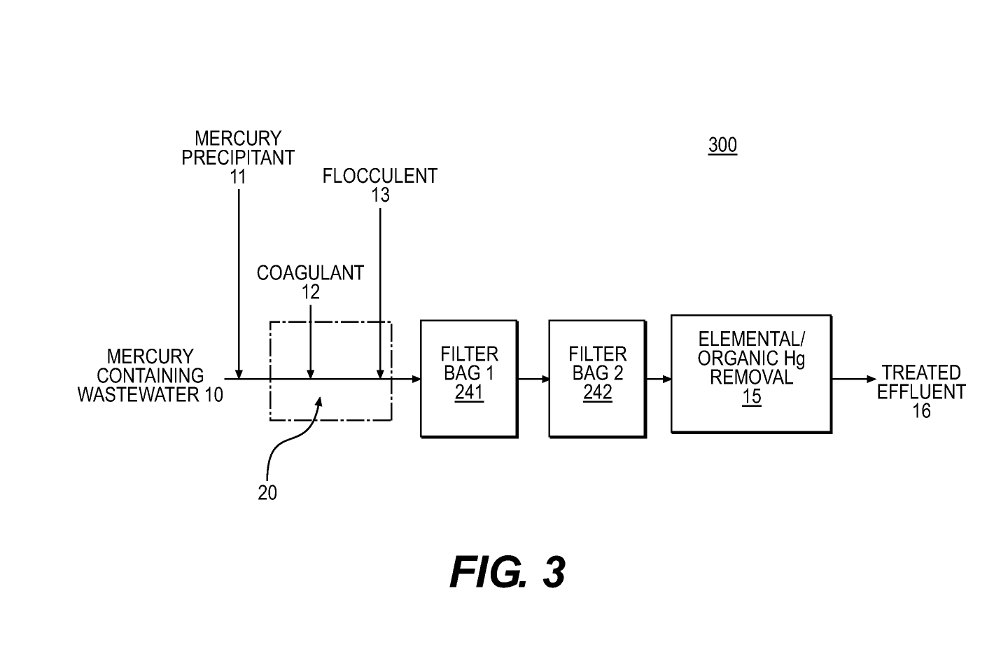

FIG. 3. illustrates another treatment unit 300 in accordance with the presently disclosed subject matter. Like treatment unit 200, treatment unit 300 includes a series of filter units 241 and 242. Each of the filter unit 241 and 242 are preferably a filter bag having a predetermined pore size. As discussed above in connection with unit 100, the unit 300 may have a plurality of units 241 and 242 arranged in parallel. The filter units 241 and 242 preferably have differing pore sizes. The pore size of the first filter unit 241 being larger than the pore size of the second filter unit 242. It is contemplated that additional filter units may be connected in series. With such an arrangement, the pore size of each subsequent filter unit will be less than the pore size of the preceding filter unit. Unlike the treatment unit 200, the treatment unit 300 includes the use of a water-soluble mercury precipitant fed through line 11, a coagulant fed through line 12 and a flocculent fed through line 13 to mix with the aqueous solution. The precipitated solids, and other mercury particulates, are separated from the aqueous stream by filtration as the aqueous stream flows through the filter units 241 and 242. The filtered aqueous stream is then fed to treatment unit 15. The aqueous stream, essentially free of all mercury species, then leaves the treatment unit 15 through line 16 and can be followed by other treatment steps that may be necessary or desirable, for example, biotreatment to reduce chemical oxygen demand or, if the stream is by now in compliance with applicable regulations, discharged to the environment.

The proper selection of the pore size of the surface filters in the filtration unit is necessary to ensure removal/filtration within the filtration unit. The pore size may vary (e.g., from 2.5 microns to 425 microns). Pore sizes that are less than 2.5 microns are considered to be well within the scope of the presently disclosed subject matter. Typically, the removal efficiency decreases with the increase in pore size. For example, the removal efficiency for a filtration unit having a pore size of 2.5 microns is between 66% and 83%. The removal efficiency for a filtration unit having a pore size of 25 microns is between 50% and 76%. The removal efficiency for a filtration unit having a pore size of 180 microns is roughly 30%.

The mercury removal process and treatment unit in accordance with the presently disclosed subject matter is applicable to aqueous streams that contain mercury, including wastewater and produced water streams. As noted above, such aqueous streams are frequently associated with the production and refining of mercury-containing hydrocarbons and with production of petrochemical streams made from such hydrocarbons. The aqueous streams may be encountered close to the zone of production or, conversely, may be encountered at distant processing sites if the hydrocarbons have not been treated to remove mercury before shipping. The process and treatment units in accordance with the presently disclosed subject matter are effective at treating streams that contain levels of mercury up to 60,000 ng/l (nanograms per litre, equal to 60 ppb) to remove mercury down to acceptable levels. It is contemplated that the process and treatment units are suitable for streams in excess of 60,000 ng/l. It is contemplated that streams in excess of 60,000 ng/l may require the use of a plurality of filter units arranged in series

The aqueous stream containing the mercury species may be subjected to an initial precipitation step to convert soluble mercury compounds in ionic form to an insoluble condition so that the compounds may be subsequently removed by the filtration unit 100, 200, 300. A mercury precipitant, that is, a compound which will react with dissolved mercury cations, usually Hg²⁺, is brought into contact with the aqueous stream in this step of the process. Contact may be achieved by simply adding a solution of the precipitant to the aqueous stream and mixing to ensure adequate contact. Mixing may occur within line 10 or within a holding tank 20. While the mixing of the mercury precipitant with the aqueous stream may be accomplished by means such as, coagulant-type mix tanks, towers with contact trays, countercurrent contactors or other devices intended to mix the added precipitant solution and distribute it uniformly throughout the mercury-containing water stream, these will generally not be necessary. Normally, it suffices to add a solution of the precipitant to the aqueous stream flow at normal flow rates, ensuring, however, that good mixing is achieved in order to permit the reaction between the precipitant and the dissolved ionic mercury to take place. This may be achieved in an area of high turbulence, such as the suction side of a pump. If, however, a sump is present at the inlet of the flotation tank for mixing in coagulants or flocculants, this can conveniently be used as a location for injection of the precipitant with good mixing assured before treatment in the filtration unit 100 or 300. When coagulants or flocculants are added in conjunction with a mercury precipitant care must be taken to ensure compatibility. For example, if an anionic precipitant and cationic coagulant are used in conjunction, adequate mixing should be provided between injection points to avoid adverse interactions between the products. The mercury precipitant is preferably used in the form of a solution so as to permit easy and effective mixing with the aqueous stream.

One class of mercury precipitating agents comprises sulfides that react with the dissolved mercury ions to form insoluble mercury sulfide precipitates. A preferred class of sulfide precipitants comprises the water-soluble sulfides such as hydrogen sulfide, alkali metal sulfides such as sodium sulfide and the alkali metal polysulfides, alkaline earth metal sulfides, alkaline earth metal polysulfides, which are both economic and commercially available. Other materials that may be used to precipitate the mercury in sulfide form include the thiazoles, alkali metal thiocarbamates, alkali metal dithiocarbamates, alkali metal xanthates and alkali metal trithiocarbonates, such as sodium trithiocarbonate (Na₂CS₃). The appropriate amount of the precipitant may be empirically determined.

To satisfy the need for a metal scavenging agent that is less toxic and also forms a large, fast settling floc, highly efficient metal chelating polymers have become commercially available and these are useful as mercury precipitants in the present process. Water soluble polymers of this type include the polydithiocarbamates which may be used effectively in the present process with a reduced risk of discharge of either the mercury itself or of a toxic treating agent. The amount of the added water-soluble polymeric dithiocarbamate is up to 30 ppmw. Polymers of this type are described, for example, in U.S. Pat. Nos. 5,500,133; 5,523,002; 5,658,487; 5,164,095; and 5,510,040 and are currently marketed by Betz-Dearborn Inc. and Nalco Inc., under the respective trade names of METCLEAR™ 2405 and NALMET™. Precipitants of this type are preferred for use in view of their ability to produce a flocculent precipitate that can be readily separated in the filtration unit 100, 200, 300 although, again, coagulants and flocculants may be added. In streams containing up to 60 ppb mercury, the use of the water-soluble polymeric dithiocarbamates in amounts up to 30 ppm has been found adequate for substantial mercury removal but in all cases, the necessary amount relative to the level of ionic mercury contaminant should be determined empirically or by reference to supplier directions. In an aqueous stream containing mercury in an amount up to 200 ppb, the amount of water-soluble polymeric dithiocarbamate is up to 50 ppm.

The mercury precipitants are normally used at near-neutral or slightly alkaline conditions, with pH values close to 8 being typical, although lower and higher pH values can be tolerated. The pH is preferably maintained in the range from about 6 to about 9 when the mercury precipitant is added to the aqueous stream. The molar amount of the selected precipitant should at least equal the amount of mercury ions to be removed with a slight excess preferably being present. The use of large excesses of precipitants such as sodium sulfide should, however, be avoided as they may lead to the formation of water-soluble mercury sulfide complexes that inhibit removal of mercury by the present process. Additionally, excessive amounts of sulfides and other precipitants of this type could exceed the amounts permitted in water discharges and since certain of these precipitants may be toxic in themselves, care must be taken to ensure that they are not present in the discharged wastewater. Another reason for not using excessive amounts of precipitant is that residual amounts will tend to be adsorbed upon the granular activated carbon bed and will load up the bed prematurely. The optimal amount of precipitant should, for this reason, not exceed the mercury content by more than one order of magnitude. Temperatures during the precipitation step can suitably range from 10°-40° C. (about 50°-100° F.) although temperatures outside this range are not to be excluded. The average residence time in the precipitation step should be long enough to enable the reaction to take place through the body of liquid and for the precipitate to form fully. Normally residence times from 10 to 20 minutes will be adequate and sufficient.

The metal complex precipitates formed by reaction of the mercury with precipitants such as the sulfides, polysulfides, mercaptans, thiocarbonates, thiocarbamates and xanthates are usually in the form of fine solids that may not settle or filter easily and for this reason, are susceptible to clogging and may even pass through the filtration unit. Addition of a coagulant or flocculating agent is preferable to achieve efficient removal of these suspended solids even when using the preferred polymeric dithiocarbamate precipitants. Additionally, coagulant or flocculating agents may be required in services with high levels of influent free hydrocarbon and/or suspended solids to help remove these contaminants and avoid adverse interactions with the mercury precipitant. Suitable coagulants and flocculants are organic or inorganic, or a combination of the two, and may be polymeric, either anionic or cationic and usually can be categorized as polyelectrolytes such as sodium aluminate, aluminum trihydrate, and ferric chloride. Polymeric organic coagulants and flocculants include the polyacrylamides, diallyldimethylammonium chloride (DADMAC) polymers, DADMAC-polyacrylamides and epichlorohydrin dimethylamine (EPI-DMA) polyamines. These coagulants and flocculants are typically added to streams prior to treatment by flotation; they may continue to be used in the present process to promote separation of the precipitated mercury compounds. The amount of coagulant or flocculent is generally in line with existing practices for removing suspended solids since the amount of precipitated mercury compound is not great. Typically, up to about 50 ppm is used, depending on the nature of the coagulant or flocculent and in most cases, less than 25 ppm will be sufficient, e.g. 10 ppm.

Following the addition of the precipitant and any coagulating or flocculating agent, the aqueous stream and the precipitate of the insoluble mercury compound are transmitted to the filter unit or filter units where the majority of the precipitate is removed by filtration (the mercury particle size is larger than the pore openings of the bag filter and so, are trapped within the filter bag).

Filter bags of the filter units can be made from polypropylene, polyester, or similar materials. They can be large (e.g., 15 feet diameter by 20 feet length), which are commercially available from various vendors, and simply placed inside a typical metal trough or container, as shown in FIG. 4. In this configuration, the system will require piping or hose to route the aqueous stream into the bag, some spacing material to place between the bag surface and the sides of the metal container to avoid creating a seal, some means of measuring or estimating differential pressure across the bag, a drain hole in the metal trough to allow the water that travels through the bag to exit the container, and pipe or hose to route the effluent leaving the container to downstream treatment or discharge. An alternate configuration is to incorporate a bag filter vessel. This could be a closed metal vessel that is constructed specifically to house numerous (from 1 to >20 bags) standard size, smaller bags (e.g. 7″ diameter and 32″ long,). If volatile hydrocarbons are likely to be present in the aqueous stream, a closed filter bag system should be considered.

The small filter bag configuration provides the ability to organize multiple stages of bag filtration in series, as shown in FIGS. 2 and 3. This can eliminate the need for upstream injection of mercury precipitants as well as coagulants and flocculants, because vessels containing larger pore size openings can be arranged in the first stage to remove large solids and free-phase hydrocarbon present in the influent aqueous stream. Then the second stage can contain vessels with a much smaller pore size to remove the mercury solids. In some situations the vessels containing the smaller pore opening size bags could not be used alone, because the run length would be might be considered unmanageable.

Using filtration, the precipitated solids and other mercury particulate compounds are retained inside the filter bags. The filtration step may also remove hydrocarbons that may be present in the water; normally, hydrocarbons present will be trapped within the filter bag. Once the differential pressure across the filter bag reaches about 20 to 30 psig, it must be removed from service and replaced with a fresh filter bag. The “spent” filter bag can be moved to a dedicated area to allow some of the entrained free water to drain or evaporate. Care must be taken to ensure any drained water is collected for further treatment and/or discharge consistent with local requirements. The drained water is not expected to contain mercury, but may require additional treatment for BOD or some other contaminant removal before discharge from the site.

The filtered aqueous stream can be routed to a treatment unit 15 to perform a polishing step to remove any trace concentrations of other mercury species (i.e., elemental and organic) if required based on local discharge requirements and/or the specific source and nature of the raw wastewater (e.g., unique process that results in elevated concentrations of dissolved mercury species). Activated carbon can be used for this purpose as it has been shown to remove dissolved ionic mercury species as well as elemental and organic forms of mercury. Carbon also can act as a final guard bed for suspended solids. A notable feature of the present technique is that the carbon is more selective for mercury than for dissolved organics or chemical oxygen demand (COD) with the result that the bed remains active for mercury removal even after the ability to remove organics has dissipated, as shown by an increase in the COD of the activated carbon filtrate. There are alternatives to activated carbon that can be used for this polishing step depending on the specific characteristics (e.g., mercury speciation) of the wastewater; however, activated carbon is preferred as it should remove the widest range of mercury species. Further, mercury speciation analysis is difficult at best and there is no method to provide confidence that the mercury species present in a particular wastewater will not change in the future as a result of changes in process conditions, feedstock qualities, etc.

The type of carbon most preferred in this step is granular activated carbon with an average particle size from 0.8 to 1.0 mm although particle sizes both above and below this range may be found suitable. A preferred type of carbon is standard bituminous coal based activated carbon. Carbons of this kind are widely available commercially from suppliers such as Calgon Carbon Corporation, Pittsburgh Pa., Fresh Water Systems, Greenville S.C. and Res-Kem Corp Media, Pa. Flow rates over the granular carbon beds using a downflow regime can typically be 1 to 2 l/m²/min (about 3-5 gal/ft²/min). A minimum of two activated carbon columns in series is preferred with operation in a lead/polish configuration. In this configuration, lead bed breakthrough can be tolerated, allowing the lead bed to stay on-line longer and become more heavily loaded. The polish bed removes any residual mercury allowing for mercury-free effluent. After the lead bed is spent, it is replaced with fresh carbon and then becomes the polish bed. The use of powdered activated carbon (PAC) in a slurry contact reactor with the PAC removed in a subsequent solids separation stage would be less preferred both in terms of cost and the ability to remove particulates without the additional solids separation stage. Another option would be PAC addition to an existing activated sludge biological treatment unit.

It will be apparent to those skilled in the art that various modifications and/or variations may be made without departing from the scope of the present invention. Thus, it is intended that the present invention covers the modifications and variations of the apparatus and methods herein, provided they come within the scope of the appended claims and their equivalents.

1. A method for removing mercury from an aqueous stream, comprising:
providing an aqueous stream containing mercury; and
passing the aqueous stream through a filtration unit to remove mercury forming a filtered aqueous stream having reduced mercury content, wherein the filtration unit includes at least one surface filtration unit, wherein the aqueous stream passes through the at least one surface filtration unit in order to form the filtered aqueous stream.

2. The method according to claim 1, further comprising:
adding at least one mercury precipitant to the aqueous stream prior to passing the aqueous stream through the filtration unit, wherein the at least one mercury precipitant reacts with mercury dissolved in the aqueous stream to form a water-insoluble precipitate of a mercury compound.

3. The method according to claim 2, wherein the water-insoluble precipitate is filtered out of the aqueous stream as the aqueous stream passes through the at least one surface filtration unit.

4. The method according to claim 2, wherein the at least one mercury precipitant comprises a compound that reacts with the dissolved mercury compounds in the aqueous stream to form water-insoluble sulfides of mercury.

5. The method according to claim 4, wherein the compound is at least one of an alkali metal sulfide, an alkali metal polysulfide, an alkaline earth metal sulfide, an alkaline earth metal polysulfide.

6. The method according to claim 2, wherein the at least one mercury precipitant reacts with the dissolved mercury compounds present in the aqueous stream to form a water-insoluble compound of mercury, wherein the at least one mercury precipitant is at least one of a thiazole, an alkali metal thiocarbamate, an alkali metal dithiocarbamate, an alkali metal xanthate or an alkali metal trithiocarbonate compound.

7. The method according to claim 2, wherein the at least one mercury precipitant comprises a water-soluble polymeric dithiocarbamate that reacts with the dissolved mercury compounds present in the stream to form a water-insoluble compound of mercury.

8. The method according to claim 2, further comprising:
adding an amount at least one of a coagulant and a flocculent to the aqueous stream prior to passing the aqueous stream through the filtration unit.

9. The method according to claim 8, further comprising:
mixing the at least one of a coagulant and a flocculent with the at least one mercury precipitant within the aqueous stream prior to passing the aqueous stream through the filtration unit.

10. The method according to claim 8, wherein the amount of coagulant and flocculent is less than 25 ppm.

11. The method according to claim 1, further comprising:
passing the filtered aqueous stream through a treatment unit to remove residual mercury contained in the filtered aqueous stream.

12. The method according to claim 11, wherein the treatment unit contains an activated carbon.

13. The method according to claim 12, wherein the activated carbon comprises granular activated carbon having an average particle size from 0.8 to 1.0 mm.

14. The method according to claim 13, wherein the activated carbon comprises bituminous coal based activated carbon.

15. The method according to claim 12, wherein the flow rate of the filtered aqueous stream over the granular carbon is 1 to 2 l/m2/min.

16. The method according to claim 1, wherein each of the at least one surface filtration unit having a surface filter.

17. The method according to claim 16, wherein the surface filter is in the form of an open end compartment having porous side walls such that the aqueous stream flows into the surface filter through the open end into an interior of the compartment, wherein the aqueous stream flows through the porous side walls to remove mercury forming a filtered aqueous stream having reduced mercury content.

18. The method according to claim 17, wherein the filtration unit comprises a first surface filtration unit having pores having a first size and a second filtration unit having pores having second size, wherein the first size is greater than the second size.

19. A treatment unit for removing mercury from an aqueous stream, comprising:
a filtration unit to remove mercury the aqueous stream forming a filtered aqueous stream having reduced mercury content, wherein the filtration unit includes at least one surface filtration unit, wherein the aqueous stream passes through the at least one surface filtration unit in order to form the filtered aqueous stream.

20. The treatment unit according to claim 19, further comprising:
a source of at least one mercury precipitant for mixing with the aqueous stream prior to passing the aqueous stream through the filtration unit, wherein the at least one mercury precipitant reacts with mercury dissolved in the aqueous stream to form a water-insoluble precipitate of a mercury compound.

21. The treatment unit according to claim 20, further comprising:
a source of an amount at least one of a coagulant and a flocculent for mixing with the aqueous stream prior to passing the aqueous stream through the filtration unit.

22. The treatment unit according to claim 19, further comprising:
an additional treatment unit to remove residual mercury contained in the filtered aqueous stream.

23. The treatment unit according to claim 22, the additional treatment unit contains an activated carbon.

24. The treatment unit according to claim 19, wherein each of the at least one surface filtration unit having a surface filter.

25. The treatment unit according to claim 24, wherein the surface filter is in the form of an open end compartment having porous side walls such that the aqueous stream flows into the surface filter through the open end into an interior of the compartment, wherein the aqueous stream flows through the porous side walls to remove mercury forming a filtered aqueous stream having reduced mercury content.

26. The treatment unit according claim 25, wherein the filtration unit comprises a first surface filtration unit having pores having a first size and a second filtration unit having pores having second size, wherein the first size is greater than the second size.
